(19) United States
(12) Patent Application Publication
(10) Pub. No.: US 2025/0382895 A1
(43) Pub. Date: Dec. 18, 2025

(54) ONLINE ROTOR THRUST ADJUSTMENT SYSTEM

(71) Applicant: NUOVO PIGNONE TECNOLOGIE -S.R.L., Florence (IT)

(72) Inventors: Riccardo MIGLIORINI, Florence, Firenze (IT); Stefano CIONCOLINI, Florence, Firenze (IT); Federico SORGONA', Florence, Firenze (IT); Stefano ARIENZALE, Florence, Firenze (IT)

(21) Appl. No.: 18/878,406

(22) PCT Filed: Jun. 27, 2023
(86) PCT No.: PCT/EP2023/025295

§ 371 Date: Dec. 23, 2024

(30) Foreign Application Priority Data
Jun. 30, 2022 (IT) 102022000013819

(51) Int. Cl. F01D 25/16; F01D 3/04; F02C 6/08; F02C 9/18

(52) U.S. Cl. CPC F01D 25/164; F01D 3/04; F02C 6/08; F02C 9/18

(57) ABSTRACT

An online rotor thrust adjustment system is disclosed. The online rotor thrust adjustment system comprises at least an axial thrust balance flow net between a compressor and an expander of a gas turbine, the axial thrust balance flow net feeding high pressure gas from the compressor to an axial thrust balance piston cavity; wherein an open loop flow regulator is arranged along the axial thrust balance flow net.

### TECHNICAL FIELD

The present disclosure concerns a system for balancing loads on a thrust bearing of a gas turbine engine rotor. Embodiments disclosed herein specifically concern adjusting the rotor thrust in real-time with a regulating valve that is manually operated from outside the engine package.

### Background Art

The rotating parts of a turbine unit always generate an axial thrust under the action of the pressure difference between the intake and exhaust.

For example, in “Oil & Gas” applications, axial thrust on the bearing of a gas turbine may usually be in the range from 10,000 N to 100,000 N.

It is very difficult and expensive to provide a thrust bearing able to withstand such a high axial thrust.

In order to solve this problem, high-pressure gas is used from the compressor and is fed into a piston cavity for balancing at least part of the axial thrust.

Processes have been developed for testing the balance system and its associated control unit during production so that the complex algorithm is properly calibrated. However, similar processes or systems are not available for the complex algorithm to be recalibrated in the field once the engine undergoes changes out of the original operating profile and configuration, such as for example changes caused by deterioration, wear, or replacement of parts. Normally, this also occurs on first installation or in case of an operational configuration change (e.g. water injection). Each of these factors has a direct effect on engine components, which influence the load on the rotor thrust bearing and, correspondingly, on the amount of pressure required in a balance piston cavity to offset such loads. Currently, the regulation of this air flow rate is managed by online fixed orifices onboard the machine, suitably designed. Each time a recalibration is needed, fixed orifices are replaced by physical disassembly of the lines causing machine downtime.

Accordingly, it would be highly desirable for a system to be developed in which the axial thrust balance control unit is calibrated while the engine is operating in the field. Further, it would also be desirable if this calibration process is performed during normal engine operation without the need for shutdown.

Most importantly, it would be desirable that such rotor thrust adjustment system is operated through an open loop control system, to increase overall reliability of the system.

### SUMMARY

In one aspect, the subject matter disclosed herein is directed to an online rotor thrust adjustment system, comprising at least an axial thrust balance flow net arranged between a compressor and an expander of a gas turbine, the axial thrust balance flow net feeding high pressure gas from the compressor to the expander, in order to at least partially balance the axial thrust; wherein an open loop flow regulator is arranged along the axial thrust balance flow net, to regulate the size of the passage through the axial thrust balance flow net.

In another aspect, the subject matter disclosed herein concerns an online rotor thrust adjustment system wherein a manual valve is arranged along the axial thrust balance flow net, the manual valve comprising a stem and a wheel, the wheel and a portion of the stem being arranged outside the gas turbine enclosure, the wheel being removably coupled with the stem. In particular, according to this aspect of the subject matter disclosed herein, at least part of the axial thrust balance flow net is comprised of flexible hoses.

In another aspect, disclosed herein is an online rotor thrust adjustment system wherein an open loop flow regulator is arranged along the axial thrust balance flow net, the rotor thrust adjustment system comprising instrumentation for reading thrust balancing pressures, safety instrumentation, and a graphic control panel page identifying balancing pressures, valve position and equivalent reference orifice size.

The rotor thrust adjustment system according to the present disclosure is intended to replace the prior art rotor thrust adjustment systems with a new circuit based on the use of a manual valve, instead of the orifices currently in use, regulates the correct flow rate and pressure of the balancing line. The weight and dimensions of the components of the rotor thrust adjustment system according to the present disclosure are such that they can be assembled on site, by operators without lifting equipment.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawing, wherein:

FIG. 1 illustrates a schematic of a first gas turbine including an online rotor thrust adjustment system according to the present disclosure; and

FIG. 2 illustrates a schematic of a second gas turbine including an online rotor thrust adjustment system according to the present disclosure.

### DETAILED DESCRIPTION OF EMBODIMENTS

Reference now will be made in detail to one embodiment of the disclosure, an example of which is illustrated in the drawing. Such example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

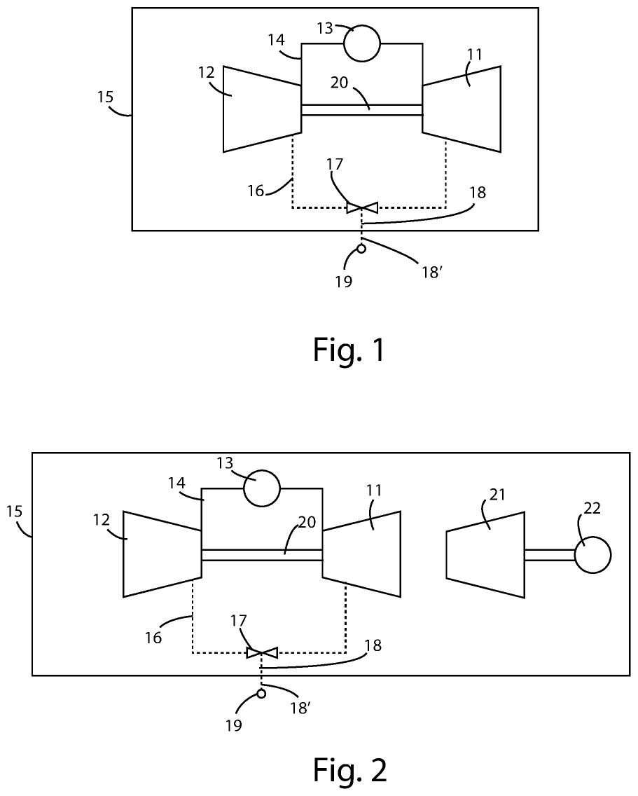

Referring now to the drawing, FIG. 1 shows a schematic of an exemplary gas turbine. The gas turbine engine is comprised of an expander 11 and a compressor 12, the expander 11 being mechanically connected to the compressor 12 by a shaft 20. The expander 11 is additionally connected to the compressor 12 through a line 14, to feed gas from the compressor 12 to the expander 11. A combustor 13 is arranged along the line 14 and is configured to realize combustion of the gas received from the compressor 12 and consequently increase its volume. The combustion gas is then provided to the expander 11, wherein the potential energy of the combustion gas is converted into kinetic energy. The gas turbine is housed within an enclosure 15, in order to isolate it from the outside. In particular, cooling air is fed in the room between the gas turbine and the enclosure 15, to control the temperature of the gas turbine and keep the temperature of the enclosure 15 within safety levels.

FIG. 1 also shows a rotor thrust adjustment system according to an embodiment of the disclosure. In particular, the rotor thrust adjustment system comprises an axial thrust balance flow net 16 arranged between the compressor 12 and the expander 11, in particular connecting the secondary flow system of the compressor with the secondary flow system of the turbine. A portion of high pressure gas from the compressor 12 is withdrawn from the compressor 12 and fed to the turbine 11, in particular to an axial thrust balance piston cavity, wherein the pressure of the gas is used to counterbalance the rotor thrust.

A flow regulator 17, arranged along the axial thrust balance flow net 16, is also shown. In particular, the flow regulator 17 is an open loop flow regulator 17 and is composed of a manual valve 17 comprising a stem 18 and a wheel 19, the wheel 19 and a portion 18′ of the stem 18 being arranged outside the gas turbine enclosure 15. Manual handling with a hand wheel 19 does not exclude the possibility of a motorised actuation.

At least a portion of the axial thrust balance flow net 16 is composed of flexible hoses, to absorb thermal expansions and vibrations of the engine, preventing mechanical stress is transmitted to the enclosure 15, supporting the manual valve 17 and preventing static and dynamic stresses is transmitted to the flanges on the machine. The valve needs to have the wheel 19 placed outside the enclosure 15, in order to be manually actuated from the outside. However, the valve body remains inside the enclosure as well as all the piping of the axial thrust balance flow net 16, given the high temperatures and noise produced during operation of the gas turbine. Flexible metal hoses can be conveniently used, minimising their diameter so as not to create encumbrances and therefore using the solution with an internal liner to allow operation with high speed flows. Materials and hose conformation are designed for any specific gas turbine operating pressures and temperatures.

The valve wheel 19 is detachable and external to the enclosure wall, to avoid overheating, which can be harmful for operators.

In some embodiments, a globe valve is used, as it is among the most reliable valves in terms of position retention and resilience to faults.

The operating position of the valve 17, which must mimic the functionality of orifices according to the prior art, is ensured by the use of a calculation and graphic table that correlates the valve opening to the size of different orifice.

Referring now to FIG. 2, an online rotor thrust adjustment system according to the present disclosure can also be applied to a turbine engine. The same reference numbers designate the same or corresponding parts, elements or components already illustrated in FIG. 1 and described above, and which will not be described again. A power turbine 21 is additionally shown, downstream of the compressor 12 and the expander 11 (that may be called “high-pressure turbine” or “high pressure expander”) and provides kinetic energy to a load 22.

While aspects of the invention have been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

1. An online rotor thrust adjustment system for balancing loads on a rotor thrust of a gas turbine during operations in response to out of design operating profile and configuration of the gas turbine, the gas turbine comprising
an expander being located downstream of a compressor;
a combustor configured to receive gas from the compressor through a line, realize gas combustion and provide combustion gas to the expander;
the gas turbine being housed within an enclosure;
the rotor thrust adjustment system comprising an axial thrust balance flow net between said compressor and said expander, to feed high pressure gas from the compressor to an axial thrust balance piston cavity;
the rotor thrust adjustment system having an open loop flow regulator arranged along said axial thrust balance flow net.

2. The online rotor thrust adjustment system of claim 1, wherein the open loop flow regulator is a manual valve comprising a stem and a wheel, the wheel and a portion of the stem being arranged outside the gas turbine enclosure.

3. The online rotor thrust adjustment system of claim 2, wherein the wheel is removably coupled with the stem.

4. The online rotor thrust adjustment system of claim 1, wherein at least part of the axial thrust balance flow net is comprised of flexible hoses.

5. The online rotor thrust adjustment system of claim 1, wherein the open loop flow regulator is a globe valve.

6. The online rotor thrust adjustment system of claim 1, wherein the open loop flow regulator is regulated trough a table replicating equivalent reference orifice size.
